(19) United States
(12) Patent Application Publication
(10) Pub. No.: US 2023/0145058 A1
(43) Pub. Date: May 11, 2023

(54) ELECTRODE FOR ELECTROLYTIC CAPACITOR, METHOD FOR MANUFACTURING SAME, AND ELECTROLYTIC CAPACITOR

(71) Applicant: Panasonic Intellectual Property Management Co., Ltd., Osaka (JP)

(72) Inventors: Takahiro YOSHINO, OSAKA FU (JP); Hiroaki SUZUKI, OSAKA FU (JP); Hitoshi ISHIMOTO, HYOGO KEN (JP); Toshiyuki KATO, SAGA KEN (JP); Masahiro UEDA, SAGA KEN (JP)

(21) Appl. No.: 17/802,065

(22) PCT Filed: Feb. 10, 2021
(86) PCT No.: PCT/JP2021/005099

§ 371 Date: Aug. 24, 2022

(30) Foreign Application Priority Data
Feb. 28, 2020 (JP) 2020-032537

(51) Int. Cl. H01G 9/042; H01G 9/025

(52) U.S. Cl. CPC H01G 9/042; H01G 9/025

(57) ABSTRACT

A method for producing an electrode for an electrolytic capacitor, the method including: a chemical conversion step of allowing a current to flow through a metal material containing a valve metal in a chemical conversion solution containing an electrolyte, to form an oxide film on a surface of the metal material, wherein the chemical conversion solution contains a nitrate-based compound as the electrolyte at a concentration of 0.03 mass % or more, and a phosphorus compound concentration in the chemical conversion solution is less than 0 01 mass %.

### CROSS-REFERENCE TO RELATED APPLICATIONS

This application is the U.S. National Phase under 35 U.S.C. § 371 of International Patent Application No. PCT/JP2021/005099, filed on Feb. 10, 2021, which in turn claims the benefit of Japanese Patent Application No. 2020-032537, filed on Feb. 28, 2020, the entire content of each of which is incorporated herein by reference.

### TECHNICAL FIELD

The present invention relates to an electrode for an electrolytic capacitor and a method for producing the same, and an electrolytic capacitor.

### BACKGROUND ART

As an anode body of a capacitor element, a metal foil or porous sintered body including a valve metal is used. On a surface of the metal foil or porous sintered body, a chemical conversion-treated oxide film is formed. For the chemical conversion treatment, usually, an aqueous phosphoric acid solution is used (e.g., Patent Literature 1).

### CITATION LIST

### Patent Literature

[PTL 1] Japanese Laid-Open Patent Publication No. 2011-77257

### SUMMARY OF INVENTION

### Technical Problem

In an electrolytic capacitor having an oxide film formed using an aqueous phosphoric acid solution, the leakage current may increase in some cases.

### Solution to Problem

A first aspect of the present invention relates to a method for producing an electrode for an electrolytic capacitor, the method including: a chemical conversion step of allowing a current to flow through a metal material containing a valve metal in a chemical conversion solution containing an electrolyte, to form an oxide film on a surface of the metal material, wherein the chemical conversion solution contains a nitrate-based compound as the electrolyte at a concentration of 0.03 mass % or more, and a phosphorus compound concentration in the chemical conversion solution is less than 0.01 mass %.

A second aspect of the present invention relates to a method for producing an electrode for an electrolytic capacitor, the method including: a chemical conversion step of allowing a current to flow through a metal material containing a valve metal in a chemical conversion solution containing an electrolyte, to form an oxide film on a surface of the metal material, wherein the chemical conversion solution contains a nitrate-based compound as the electrolyte, a phosphorus compound concentration in the chemical conversion solution is less than 0.01 mass %, and a temperature of the chemical conversion solution in the chemical conversion step is 40° C. or higher.

A third aspect of the present invention relates to an electrode for an electrolytic capacitor, including: a metal material including a valve metal; and an oxide film formed on a surface of the metal material, wherein a phosphorus concentration measured by an energy dispersive X-ray spectroscopy of the oxide film is below a detection limit.

A fourth aspect of the present invention relates to an electrode for an electrolytic capacitor, including: a metal material including a valve metal; and an oxide film formed on a surface of the metal material, wherein a phosphate ion fragment peak intensity measured by time-of-flight secondary ion mass spectrometry of the oxide film is below a detection limit.

A fifth aspect of the present invention relates to an electrode for an electrolytic capacitor, including: a metal material including a valve metal; and an oxide film formed on a surface of the metal material, wherein the oxide film includes an oxide of tantalum, and in a spectrum obtained by an electron energy loss spectroscopy of the oxide film, a difference between an average intensity I_{1A} of a first peak observed between 530 eV and 550 eV and an average intensity I_{2A} of a second peak observed between 560 eV and 570 eV is 10% or less of the average intensity I_{1A} of the first peak.

A sixth aspect of the present invention relates to an electrode for an electrolytic capacitor, including: a metal material including a valve metal; and an oxide film formed on a surface of the metal material, wherein the oxide film contains an oxide of tantalum, and in a spectrum obtained by an electron energy loss spectroscopy of the oxide film, an intensity L of a first peak observed between 530 eV and 550 eV is smaller as nearer to a surface of the metal material.

A seventh aspect of the present invention relates to an electrode for an electrolytic capacitor, including: a metal material including a valve metal; and an oxide film formed on a surface of the metal material, wherein the oxide film contains an oxide of tantalum, and in a spectrum obtained by an electron energy loss spectroscopy of the oxide film, a fourth peak adjacent to a third peak attributed to Ta-N1 edge, on a high energy side of the third peak, is observed at 570 eV or higher.

### Advantageous Effects of Invention

According to the present invention, an electrolytic capacitor with suppressed leakage current can be obtained.

While the novel features of the invention are set forth particularly in the appended claims, the invention, both as to organization and content, will be better understood and appreciated, along with other objects and features thereof, from the following detailed description taken in conjunction with the drawings.

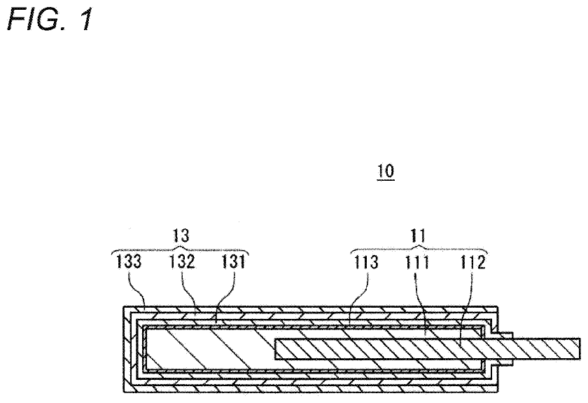

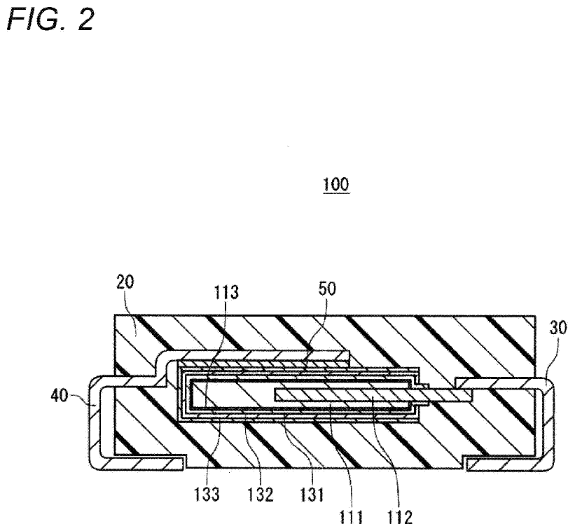

### BRIEF DESCRIPTION OF DRAWINGS

[FIG. 1] A schematic cross-sectional view of a capacitor element according to one embodiment of the present invention.

[FIG. 2] A schematic cross-sectional view of an electrolytic capacitor according to one embodiment of the present invention.

### DESCRIPTION OF EMBODIMENTS

When an aqueous phosphoric acid solution is used, a small amount of phosphorus atoms will enter and be present in the formed oxide film. Due to the presence of phosphorus atoms, electrically conductive paths are formed in the oxide film serving as an insulator. Moreover, due to the generation of impurity levels in the band gap, the emission of electrons into the oxide film tends to be facilitated. This presumably causes a leakage current of the electrolytic capacitor.

The present inventors have found that when a nitrate-based compound is used as the chemical conversion solution, nitrogen, in place of phosphorus, will enter the formed oxide film, which changes the properties of the oxide film. Especially, by controlling the concentration of the nitrate-based compound or the temperature of the chemical conversion solution, the leakage current is further suppressed.

Specifically, a method for producing an electrode for an electrolytic capacitor according to the present embodiment includes a chemical conversion step of allowing a current to flow through a metal material containing a valve metal in a chemical conversion solution containing an electrolyte, to form an oxide film on a surface of the metal material, and the chemical conversion solution contains a nitrate-based compound as the electrolyte. In a first embodiment, the nitrate-based compound is contained at a concentration of 0.03 mass % or more in the chemical conversion solution. In a second embodiment, the chemical conversion step is performed in the chemical conversion solution having a temperature of 45° C. or higher.

The oxide film formed using a nitrate-based compound has a feature different from that of an oxide film formed using another chemical conversion solution. By controlling the concentration of the nitrate-based compound or the temperature of the chemical conversion solution as described above, this feature becomes more prominent.

That is, an electrode for an electrolytic capacitor according to the present embodiment includes a metal material containing a valve metal, and an oxide film formed on the surface of the metal material. The oxide film is an oxide of a metal including a valve metal, for example, tantalum pentoxide.

### [Method for Producing Electrode for Electrolytic Capacitor]

### A-1. First Embodiment

In the chemical conversion step according to the present embodiment, the chemical conversion solution containing a nitrate-based compound contains the nitrate-based compound as an electrolyte at a concentration of 0.03 mass % or more. By this, it is possible to form an oxide film while suppressing the entry of phosphorus.

The concentration of the nitrate-based compound is preferably 15 mass % or less, in view of suppressing the corrosion of the production equipment and controlling the thickness of the oxide film. The concentration of the nitrate-based compound may be 0.04 mass % or more, and may be 0.08 mass % or more. The concentration of the nitrate-based compound may be 10 mass % or less, and may be 5 mass % or less.

The chemical conversion solution may contain an electrolyte other than the nitrate- based compound. It is desirable, however, that the concentration thereof is low. Especially, the concentration of a compound containing phosphorus is desirably low. The concentration of another electrolyte is preferably 0.01 mass % or less, more preferably 0.005 mass % or less. As another electrolyte, conventionally known electrolytes used for chemical conversion treatment can be used. Examples of another electrolyte include: inorganic acids, such as phosphoric acid, and salts thereof; organic acids, such as adipic acid, and salts thereof; and basic substances, such as ammonia.

When compared at the same concentration and temperature, the conductivity of an aqueous solution containing a nitrate-based compound is higher than that of an aqueous solution containing another electrolyte. Therefore, with a nitrate-based compound, the chemical conversion is allowed to proceed efficiently.

In the present embodiment, the temperature of the chemical conversion solution during treatment is not limited. In view of the productivity, the temperature of the chemical conversion solution may be 25° C. or higher, may be 40° C. or higher, and may be 45° C. or higher. In view of suppressing the liquid evaporation and thus suppressing the corrosion of the production equipment, the temperature of the chemical conversion solution may be 75° C. or lower. When the concentration of the nitrate-based compound is sufficiently low, for example, when the concentration of the nitrate-based compound is 1 mass % or less, the temperature of the chemical conversion solution may be 70° C. or lower. When the concentration of the nitrate-based compound exceeds 1 mass %, the temperature of the chemical conversion solution may be 55° C. or lower.

### A-2. Second Embodiment

In the chemical conversion step according to the present embodiment, the temperature of the chemical conversion solution containing a nitrate-based compound during treatment is 40° C. or higher. By this, it is possible to form an oxide film while suppressing the entry of phosphorus. In view of suppressing the liquid evaporation and thus suppressing the corrosion of the production equipment, and furthermore, controlling the thickness of the oxide film, the temperature of the chemical conversion solution during treatment is preferably 75° C. or lower. When the concentration of the nitrate-based compound is 1 mass % or less, the temperature of the chemical conversion solution may be 60° C. or higher. When the concentration of the nitrate-based compound exceeds 1 mass %, the temperature of the chemical conversion solution during treatment may be 43° C. or higher, and may be 45° C. or higher. The temperature of the chemical conversion solution during treatment may be 70° C. or lower, and may be 68° C. or lower.

In the present embodiment, the concentration of the nitrate-based compound is not limited. In view of the productivity, the concentration of the nitrate-based compound may be 0.03 mass % or more, and may be 0.05 mass % or more. In view of suppressing the corrosion of the production equipment, the concentration of the nitrate-based compound may be 15 mass % or less, and may be 10 mass % or less.

In the present embodiment, too, the chemical conversion solution may contain an electrolyte other than the nitrate-based compound. However, the concentration thereof is preferably 0.01 mass % or less, more preferably 0.005 mass % or less.

### (Nitrate-Based Compound)

The nitrate-based compound is not limited. Examples of the nitrate-based compound include nitric acid, nitrous acid, nitrate, nitrite, nitric acid ester, and nitrous acid ester. Examples of the salts of nitrate and nitrite include strontium, magnesium, calcium, barium, aluminum, zirconium, sodium and lithium. Examples of the functional group of the nitric acid ester and the nitrous acid ester include methyl group, ethyl group, and butyl group. In particular, nitric acid is preferred because it is easily available and inexpensive.

### (Metal Material)

The metal material includes a porous sintered body or a foil (metal foil) including a valve metal. When a metal foil is used, a principal surface thereof may be roughened by electrolytic etching or the like. This can increase the capacitance of the electrolytic capacitor. When a porous sintered body is used, an electrode wire embedded in the porous sintered body is partially extended from one side thereof. The electrode wire is used for connection with a lead terminal

Examples of the valve metal include titanium, tantalum, aluminum, and niobium. The metal material may include one kind or two or more kinds of the above valve metals. The metal material may include the valve metal in the form of an alloy containing the valve metal, a compound containing the valve metal, or other forms. The metal material is particularly preferably a porous sintered body containing tantalum, in terms of the chemical stability.

The thickness of the metal material in the form of a metal foil is not limited, and is, for example, 15 μm or more and 300 μm or less. The thickness of the metal material in the form of a porous sintered body is not limited, and is, for example, 15 μm or more and 5 mm or less.

### (Other Conditions for Chemical Conversion)

The chemical conversion voltage is the maximum value of the voltage applied between the metal material and a counter electrode. The chemical voltage influences the thickness of the oxide film, and further influences the withstand voltage of the electrolytic capacitor. Therefore, the chemical conversion voltage may be set as appropriate according to the rated voltage of the electrolytic capacitor, and is not limited. The chemical conversion voltage may be, for example, 5 V or more. The chemical conversion voltage may be, for example, 100 V or less.

The time for maintaining the chemical conversion voltage (chemical conversion time) is not limited, and may be set as appropriate, in consideration of the thickness of the oxide film, productivity, and the like. The chemical conversion time may be, for example, 1 hour or more. The chemical conversion time may be, for example, 20 hours or less.

The current density flowing through the metal material is not limited, and may be set as appropriate, in consideration of the chemical conversion time and the like. The maximum current density may be, for example, 0.001 mA/cm² or more. The maximum current density may be, for example, 100 mA/cm² or less.

### [Electrode for Electrolytic Capacitor]

An electrode according to the present embodiment has an oxide film on its surface. The oxide film is formed by oxidizing the surface of the metal material. Therefore, the oxide film contains an oxide of the valve metal contained in the metal material.

The thickness of the oxide film is not limited, and is set as appropriate, in consideration of the rated voltage of the electrolytic capacitor and the like. The thickness of the oxide film is, for example, 10 nm or more and 300 nm or less.

### B-1. First Embodiment

In an oxide film according to the present embodiment, the phosphorus concentration measured by energy dispersive X-ray spectroscopy (EDX) is below the detection limit. Such an oxide film can be formed on a metal material subjected to chemical conversion treatment in a chemical conversion solution containing a nitrate-based compound (hereinafter sometimes referred to as nitrate-based conversion).

The EDX is used in combination with a scanning electron microscope (SEM), a transmission electron microscope (TEM), or a scanning transmission electron microscope (STEM).

In an oxide film (hereinafter sometimes referred to as a phosphoric acid-conversion film) formed in an aqueous phosphoric acid solution, which is typically used for chemical conversion treatment, phosphorus is detected. That is, atoms that form conductive paths have relatively abundantly entered in the phosphoric acid-conversion film. On the other hand, nitrogen atoms are scarcely detected (below the detection limit). Phosphorus is abundantly detected near the surface of another oxide film.

In the oxide film according to the present embodiment, phosphorus atoms are scarcely detected, and nitrogen atoms have slightly entered. Therefore, it has properties different from those of the phosphoric acid-conversion film, and the leakage current of the electrolytic capacitor tends to be suppressed.

### B-2. Second Embodiment

In an oxide film according to the present embodiment, the phosphate ion fragment peak intensity measured by time-of-flight secondary ion mass spectrometry (TOF-SIMS) is below the detection limit. This means that the entry of phosphorus into the oxide film is scarce. On the other hand, in the oxide film according to the present embodiment, a peak presumably belonging to a fragment related to nitrogen ions is detected. From the above, the possibility of the entry of nitrogen into the oxide film can be inferred. The slight entry of nitrogen, in place of phosphorus, can change the properties of the oxide film, and the leakage current of the electrolytic capacitor can be suppressed. Such an oxide film can be formed on the metal material subjected to nitrate-based conversion.

As in the EDX analysis result, when another oxide film is analyzed by TOF-SIMS, a phosphate ion fragment peak can be detected. The ion fragment peak can be obtained by evaluating the surface of the oxide film. The oxide film may be etched to evaluate the inside thereof. The evaluation result of the inside also has the same tendency as the evaluation result of the surface.

### B-3. Third Embodiment

An oxide film according to the present embodiment includes an oxide of tantalum.

In the oxide film according to the present embodiment, a difference (=|I_{1A}−I_{2A}|) between an average intensity I_{1A} of a first peak observed between 530 eV and 550 eV and an average intensity I_{2A} of a second peak observed between 560 eV and 570 eV in a spectrum obtained by an electron energy loss spectroscopy (EELS) is 10% or less of the average intensity LA of the first peak. That is, 100·|I_{1A}−I_{2A}|/I_{1A}≤10 (%) is satisfied. Such an oxide film can be formed on the metal material subjected to nitrate-based conversion.

The first peak is attributed to O-K edge (the excitation process by K-shell electron of oxygen). The second peak is attributed to Ta-N1 edge (the excitation process of by N1-shell electron of tantalum). The relationship between the first peak and the second peak indicates the oxidation state of the tantalum atom.

When using a chemical conversion solution containing an electrolyte other than the conventionally used nitrate-based compound, for example, an inorganic acid such as phosphoric acid or a salt thereof, an organic acid such as adipic acid or a salt thereof, or a basic substance such as ammonia, the relationship between the first peak and the second peak in the formed oxide film (hereinafter referred to as another oxide film) fails to satisfy is 100−|I_{1A}−I_{2A}|/I_{1A}≤10 (%). That is, the oxide film formed by nitrate-based conversion and another oxide film are different in the oxidation state of the tantalum atom. The reason therefor is unclear at this moment, but it can be inferred that this difference influences the electronic structure of the oxide film, and effectively acts to suppress the leakage current of the capacitor.

Here, I_{1A}>I_{2A} may be satisfied, I_{1A}<I_{2A} may be satisfied, and I_{1A}=I_{2A} may be satisfied.

The average intensity I_{1A} of the first peak can be calculated as follows. The intensity of the peak observed between 530 eV and 550 eV is measured at a total of 6 points, including any one point on the surface of the oxide film, four points that divide the thickness of the oxide film on a straight line drawn from the point on the surface toward the metal material into five equal parts, and an intersecting point between the above straight line and the surface of the metal material. In addition, with respect to any other 4 points, the intensity of the peak observed between 530 eV and 550 eV is measured similarly at a total of 6 points differing in depth. The average intensity I_{1A} of the first peak refers to the average of the values measured at these 30 points.

The average intensity I_{2A} of the second peak is the average value of the intensities of the peaks observed between 560 eV and 570 eV measured at the same 30 points where the intensity of the first peak is measured. When there are a plurality of peaks observed between 530 eV and 550 eV, the peak on the lowest energy side is used. When there are a plurality of peaks observed between 560 eV and 570 eV, the peak on the lowest energy side is used.

EELS is used in combination with a scanning electron microscope (SEM), a transmission electron microscope (TEM), or a scanning transmission electron microscope (STEM).

### B-4. Fourth Embodiment

An oxide film according to the present embodiment contains an oxide of tantalum. In the oxide film according to the present embodiment, the intensity L of the first peak observed between 530 eV and 550 eV in the spectrum obtained by EELS is smaller as nearer to the surface of the metal material. That is, the electronic structure in the oxide film varies in the thickness direction with the same tendency. Such an oxide film can be formed on the metal material subjected to nitrate-based conversion.

In another oxide film, the intensity L of the first peak cannot be smaller as nearer to the surface of the metal material. For example, in another oxide film, the intensity of the first peak at the surface of the metal material can greater than that in the inside. That is, in another oxide film, the binding state of oxygen varies randomly in the thickness direction. The reason therefor is unclear at this moment, but it can be inferred that this difference influences the electronic structure of the oxide film, and effectively acts to suppress the leakage current of the capacitor.

The intensity I₁ of the first peak is measured, for example, at a total of 6 points, including any one point on the surface of the oxide film (depth: zero), four points that divide the thickness of the oxide film on a straight line drawn from the point on the surface toward the metal material into five equal parts (depth: 1 to 4), and an intersecting point between the above straight line and the surface of the metal material (depth: 5). In addition, with respect to any other 4 points, the intensity of the first peak is similarly measured at a total of 6 points differing in depth. The intensities at the five points measured at the same depth at different places are averaged, to determine the intensity of the first peak at that depth. When there are a plurality of peaks observed between 530 eV and 550 eV, the peak on the lowest energy side is used.

As a general tendency, the intensity I₁ of the first peak is smaller as nearer to the surface of the metal material. For example, at two adjacent points among the above six points at the depth zero to the depth 5, the intensity at the shallower point of the two may be greater than or equal to the intensity at the deeper point of the two. However, an intensity Iio at the depth zero is greater than an intensity I₁₅ at the depth 5.

In view of the uniformity of the quality of the oxide film, it is desirable that the difference between the intensity I₁₀ at the depth zero and the intensity I₁₅ at the depth 5 is not excessively large. The difference between the intensity Iio and the intensity I₁₅ (=(I₁₀−I₁₅)) is preferably 30% or less of the intensity ho. That is, it is preferable that 100·(=(I₁₀−I₁₅)/I₁₀≤30 (%) is satisfied. More preferably, 100·(I₁₀−I₁₅)/I₁₀≤20 (%) is satisfied.

From the same point of view, an intensity I₁₁ at the depth 1 is preferably smaller than the intensity I₁₀ at the depth zero, and the difference between the intensity I₁₀ and the intensity I₁₁ is desirably sufficiently large. The difference between the intensity I₁₀ and the intensity I₁₁ (=I₁₀−I₁₁) is preferably 3% or more and 20% or less of the intensity I₁₀. That is, it is preferable that 3 (%)≤100·(I₁₀−I₁₁)/I₁₀≤20 (%) is satisfied. More preferably, 5 (%)≤100·(I₁₀−I₁₁)/I₁₀≤20 (%) is satisfied.

### B-5. Fifth Embodiment

An oxide film according to the present embodiment contains an oxide of tantalum. In the oxide film according to the present embodiment, in a spectrum obtained by EELS, a fourth peak adjacent to a third peak attributed to Ta-N1 edge, on a high energy side of the third peak, is observed at 570 eV or higher. Such an oxide film can be formed on the metal material subjected to nitrate-based conversion.

The third peak is attributed to Ta-N1 edge (the excitation process by N1-shell electron of tantalum). The position of the fourth peak indicates the state of the distance between oxygen atoms. That the fourth peak has shifted to the high energy side means that the distance between oxygen atoms has decreased. That is, it can be inferred that the denseness of the oxide film is improved. The third peak coincides with the second peak in the third embodiment.

The fourth peak in another oxide film is observed on the lower energy side than 570 eV. That is, the oxide film formed by nitrate-based conversion and another oxide film are different in the oxidation state of the tantalum atom. The reason therefor is unclear at this moment, but it can be inferred that this difference influences the electronic structure of the oxide film, and effectively acts to suppress the leakage current of the capacitor.

The third peak and the fourth peak can be specified as follows. A spectrum by EELS is obtained at a point positioned within 10 nm (e.g., depth 5 nm) from the surface of the oxide film toward the metal material. Subsequently, the third peak attributed to Ta-N1 edge is specified. The third peak usually appears between 563 eV and 567 eV. Then, the fourth peak adjacent to this third peak is specified. It is desirable to confirm the position of the fourth peak by further evaluation at any other 9 points positioned within the depth of 10 nm of the oxide film by EELS. When the fourth peaks specified at 8 out of any 10 points are observed at 570 eV or higher, this oxide film can be regarded as satisfying the fifth embodiment.

### (Others)

In the third to fifth embodiments, it is desirable that the followings are satisfied.

a) In a spectrum obtained by EELS of the oxide film according to the present embodiment, an average intensity I_{5A} of a fifth peak observed between 1770 eV and 1790 eV is lower than an average intensity I_{5R} of the fifth peak in another oxide film.

Especially, it is preferable that the difference (=I_{5R}−I_{5A}) between the average intensity I_{5A} and the average intensity I_{5R} is 10% or more of the average intensity I_{5R}. That is, it is preferable that (I_{5R}−I_{5A})/I_{5R}≥0.1 is satisfied.

The fifth peak is attributed to Ta-M5 end (the excitation process of by M5-shell electron of tantalum).

b) In a spectrum obtained by EELS of the oxide film according to the present embodiment, an average intensity I_{6A} of a sixth peak observed between 1830 eV and 1850 eV is lower than an average intensity I_{6R} of the sixth peak in another oxide film.

Especially, it is preferable that the difference (=I_{6R}−I_{6A}) between the average intensity I_{6A} and the average intensity I_{6R} is 5% or more of the average intensity I_{6R}. That is, it is preferable that (I_{6R}−I_{6A})/I_{6R}≥0.05 is satisfied.

The sixth peak is attributed to Ta-M4 end (the excitation process of by M4-shell electron of tantalum).

The average intensity I_{5A} and the average intensity I_{6A} can be calculated similarly to the average intensity I_{1A}. The average intensity I_{5R} and the average intensity I_{6R} of the oxide film used for comparison can be calculated similarly to the average intensity I_{1A}.

In the first to fourth embodiments, it is desirable that the followings are satisfied.

(c) The value of the current (leakage current) flowing through the electrode having the oxide film according to the present embodiment is 10% or more lower than the leakage current value of the electrode having another oxide film. This can further suppress the leakage current of the electrolytic capacitor.

The leakage current value of the electrode according to the present embodiment is preferably 15% or more lower than the leakage current value of the electrode having another oxide film, and more preferably 30% or more lower.

The leakage current of the electrode is a current value measured when a voltage of 70% of the chemical conversion voltage is applied between the above electrode and a counter electrode which are immersed in an aqueous electrolyte solution.

The oxide film used for comparison can be formed using, for example, a chemical conversion solution containing phosphoric acid at a concentration of 0.1 mass %. The chemical conversion conditions therefor other than the composition of the chemical conversion solution are the same as those for the oxide film according to the present embodiment. The chemical conditions are, for example, a chemical voltage of 15 V, a temperature of 60° C., and a treatment time of 10 hours.

### [Electrolytic Capacitor]

The electrode obtained by subjecting a metal foil to chemical conversion treatment as described above can be used for a capacitor element. The capacitor element includes a first electrode, which is the aforementioned electrode, and a second electrode. The second electrode includes, for example, a solid electrolyte layer and a cathode leading layer. The leakage current of the electrolytic capacitor according to the present embodiment is 30% or more lower than the leakage current of the electrolytic capacitor including an electrode having another oxide film.

The electrolytic capacitor includes, for example, one or more of the aforementioned capacitor element, a package body for sealing the one or more capacitor elements, and a first and a second lead terminal. At least part of each lead terminal is exposed outside the package body. Such a capacitor element is in the form of, for example, a sheet or a flat plate.

### (First Electrode)

The first electrode is a metal material having an oxide film formed as described above. The first electrode is, for example, an anode.

### (Second Electrode)

The second electrode includes a solid electrolyte layer and an electrode leading layer. The second electrode is, for example, a cathode.

### (Solid Electrolyte Layer)

The solid electrolyte layer is formed so as to cover at least part of the oxide film. The solid electrolyte layer may be formed so as to cover the entire surface of the oxide film. The solid electrolyte layer may have any thickness.

The solid electrolyte layer includes one or more solid electrolyte layers. The solid electrolyte layer is formed of, for example, a manganese compound or a conductive polymer. As the conductive polymer, polypyrrole, polyaniline, polythiophene, polyacetylene, derivatives thereof, and the like can be used. The solid electrolyte layer containing a conductive polymer can be formed, for example, by chemically polymerizing and/or electrolytically polymerizing a raw material monomer on the oxide film. Alternatively, a solution or a dispersion of a conductive polymer may be applied onto the oxide film.

### (Cathode Leading Layer)

The cathode leading layer may be formed so as to cover at least part of the solid electrolyte layer, or may be formed so as to cover the entire surface of the solid electrolyte layer.

The cathode leading layer has, for example, a carbon layer and a metal paste layer formed on the surface of the carbon layer. The carbon layer is constituted of a composition containing a conductive carbon material, such as graphite. The metal paste layer is constituted of, for example, a composition containing silver particles and a resin. The configuration of the cathode leading layer is not limited thereto, and may be any configuration that has a current collecting function.

### (Lead Terminal)

The material of the first lead terminal and the second lead terminal may be any material that is electrochemically and chemically stable and has conductivity, and may be metallic or non-metallic. The shape of them is also not limited.

The first lead terminal is connected to the first electrode, and the second lead terminal is connected to the second electrode. The electrical connection between the first electrode and the first lead terminal is achieved by, for example, welding them to each other. The electrical connection between the second electrode and the second lead terminal is achieved by, for example, adhering the second electrode and the second lead terminal to each other via a conductive adhesive layer interposed therebetween.

### (Package Body)

The package body covers the capacitor element and part of each of the lead terminals. This electrically insulates the first lead terminal from the second lead terminal, and protects the capacitor element. The package body is constituted of an insulating material (package body material). Examples of the package body material include cured products of thermosetting resins, and engineering plastics.

FIG. 1 is a schematic cross-sectional view of a capacitor element according to the present embodiment.

A capacitor element 10 includes a first electrode 11 and a second electrode 13. The first electrode 11 includes a porous sintered body 111, an electrode wire 112 partially extended from the porous sintered body 111, and an oxide film 113 covering at least part of the porous sintered body 111. The second electrode 13 includes a solid electrolyte layer 131, a carbon layer 132, and a metal paste layer 133. The carbon layer 132 and the metal paste layer 133 function as a cathode leading layer. The capacitor element 10 configured as above is approximately cubic in shape.

FIG. 2 is a schematic cross-sectional view illustrating the structure of an electrolytic capacitor according to the present embodiment.

An electrolytic capacitor 100 includes a capacitor element, a package body 20 sealing the capacitor element, and a first lead terminal 30 and a second lead terminal 40 each of which is partially exposed outside the package body 20.

The electrode wire 112 and the first lead terminal 30 are electrically connected to each other by, for example, welding. The metal paste layer 133 and the second lead terminal 40 are electrically connected to each other via, for example, an adhesive layer 50 formed of a conductive adhesive (e.g., a mixture of a thermosetting resin and carbon or metal particles).

In the present embodiment, an electrolytic capacitor which uses a solid electrolyte as the electrolyte and in which the capacitor element is sealed by a package body is described, but this is not a limitation. The electrode according to the present embodiment can be applied to, for example, an electrolytic capacitor including a capacitor element formed by winding a first electrode and a second electrode with a separator interposed therebetween, and an electrolyte solution. In this case, the electrode according to the present embodiment is used for at least one of the first and second electrodes.

### EXAMPLES

The present invention will be more specifically described below with reference to Examples and Comparative Examples. The present invention, however, is not limited to the following Examples.

### Example 1

Twenty electrolytic capacitors as illustrated in FIG. 2 were produced and their characteristics were evaluated in the following manner.

### (i) Production of Capacitor Element

(i-i) Preparation of First Electrode

Tantalum metal particles were used as a valve metal. The tantalum metal particles were molded into a rectangular shape, with one end of an electrode wire made of tantalum embedded in the tantalum metal particles. The resultant molded body was sintered in vacuum. Thus, a first electrode precursor including a porous sintered body of tantalum, and an electrode wire, one end of which was embedded in the porous sintered body and the other end of which was extended from one side of the porous sintered body, was obtained.

(i-ii) Formation of Oxide Film

An aqueous 0.06 mass % nitric acid solution was prepared as a chemical conversion solution. A chemical conversion bath was filled with the chemical conversion solution, in which the porous sintered body and part of the electrode wire were immersed. The temperature of the chemical conversion solution was 60° C. The other end of the electrode wire was connected to a counter electrode, and anodization was performed at a chemical conversion voltage of 15 V for 10 hours. In this way, an oxide film (thickness: approx. 30 nm) of tantalum pentoxide (Ta₂O₅) was uniformly formed on the surface of the porous sintered body and part of the surface of the electrode wire. Twenty first electrodes X1 were prepared.

(i-iii) Formation of Solid Electrolyte Layer

A dispersion containing polypyrrole was impregnated into the porous sintered body with the oxide film formed thereon for 5 minutes, followed by drying at 150° C. for 30 minutes, thereby forming a solid electrolyte layer on the oxide film.

(i-iv) Formation of Carbon Layer

A dispersion (carbon paste) in which carbon particles were dispersed in water was applied onto the solid electrolyte layer, followed by heating at 200° C., thereby forming a carbon layer on the surface of the solid electrolyte layer.

(i-v) Formation of Metal Paste Layer

A metal paste containing silver particles, a binder resin, and a solvent was applied onto the surface of the carbon layer. This was followed by heating at 200° C. to form a metal paste layer, and thus, a capacitor element was obtained.

### (ii) Production of Electrolytic Capacitor

A conductive adhesive material was applied onto the metal paste layer, and the second lead terminal and the metal paste layer were joined to each other. The electrode wire and the first lead terminal were joined to each other by resistance welding. Next, the capacitor element with the lead terminals joined thereto and a package body material (uncured thermosetting resin and filler) were placed inside a mold, and the capacitor element was sealed by transfer molding, to complete an electrolytic capacitor.

### Example 2

Twenty first electrodes X2 were produced in the same manner as in Example 1, except that the concentration of nitric acid in the chemical conversion solution was set to 10 mass % and the temperature of the chemical conversion solution was set to 45° C., and electrolytic capacitors were produced.

### Comparative Example 1

Twenty first electrodes Y1 were prepared in the same manner as in Example 1, except that a chemical conversion solution containing phosphoric acid (concentration: 0.1 mass %), instead of nitric acid, was used, and electrolytic capacitors were produced.

### Comparative Example 2

Twenty first electrodes Y2 were prepared in the same manner as in Example 1, except that a chemical conversion solution containing diammonium adipate (concentration: 0.2 mass %), instead of nitric acid, was used, and electrolytic capacitors were produced.

### Comparative Example 3

Twenty first electrodes Y3 were prepared in the same manner as in Example 1, except that a chemical conversion solution containing ammonia (concentration: 2.5 mass %), instead of nitric acid, was used, and electrolytic capacitors were produced.

### [Evaluation]

### (1) Analysis of Oxide Film

After the formation of oxide film (i-ii), the first electrodes X1 and Y1 to Y3 were analyzed.

### (1-1) EELS Analysis

Spectral analysis was performed with a TEM-EELS apparatus. The results are shown in Table 1.

TABLE 1

| First electrode | X1 | Y1 | Y2 | Y3 |
|---|---|---|---|---|
| Average intensity I_{1A} | 6.4E+06 | 6.7E+06 | 6.3E+06 | 5.3E+06 |
| Average intensity I_{2A} | 6.3E+06 | 5.5E+06 | 5.4E+06 | 5.4E+06 |
| Average intensity I_{3A} | 6.4E+06 | 5.6E+06 | 5.5E+06 | 5.5E+06 |
| Average intensity I_{4A} | 6.5E+06 | 5.6E+06 | 5.6E+06 | 5.5E+06 |
| Intensity I₁₀ | 7.2E+06 | 7.1E+06 | 6.5E+06 | 4.6E+06 |
| Intensity I₁₁ | 6.4E+06 | 6.4E+06 | 6.1E+06 | 5.9E+06 |
| Intensity I₁₂ | 6.2E+06 | 6.7E+06 | 6.1E+06 | 6.1E+06 |
| Intensity I₁₃ | 6.2E+06 | 7.0E+06 | 6.6E+06 | 6.1E+06 |
| Intensity I₁₄ | 6.1E+06 | 6.5E+06 | 6.1E+06 | 3.6E+06 |
| Intensity I₁₅ | 6.1E+06 | 6.5E+06 | 6.4E+06 | — |
| (I_{1A} − I_{2A})/I_{1A} | 0.010 | 0.179 | 0.143 | −0.027 |
| (I₁₀ − I₁₅)/I₁₀ | 0.153 | 0.085 | 0.015 | 1.000 |
| (I₁₀ − I₁₁)/I₁₀ | 0.111 | 0.099 | 0.062 | −0.283 |
| Third peak position | 566 eV | 564 eV | 566 eV | 566 eV |
| Fourth peak position | 572 eV | 569 eV | 571 eV | 572 eV |
| (I_{5R} − I_{5A})/I_{5R} | 0.174 | — | 0.022 | 0.065 |
| (I_{6R} − I_{6A})/I_{6R} | 0.059 | — | −0.059 | 0.000 |

### (1-2) EDX Analysis

Elemental analysis of the surface of the oxide film in the first electrodes X1 and Y1 was performed with a TEM-EDX apparatus. The results are shown in Table 2.

TABLE 2

| First electrode | X1 | Y1 |
|---|---|---|
| P concentration (atm %) | (below detection limit) | 0.9 to 1.1 |
| N concentration (atm %) | 1.5 | (below detection limit) |

### (1-3) TOF-SIMS Analysis

The surface of the oxide film and the inside thereof (depth: 1 nm to 10 nm) were analyzed with a TOF-SIMS apparatus. The oxide film was etched with an Ar-gas cluster ion beam.

In the first electrodes X1 and X2, phosphate ions were not detected either at the surface or inside the oxide film (below the detection limit). In the first electrodes Y1 to Y3, phosphate ions were detected both at the surface and in the inside the oxide film.

### (2) Leakage Current

After the film formation (i-ii), the leakage current values of the first electrodes X1, Y2, and Y3 were measured.

The prepared first electrode and a counter electrode (SUS316L) were immersed in a 0.1 wt % phosphoric acid. A voltage of 70% of the chemical conversion voltage was applied between the electrodes, to measure the current value flowing through the first electrode, and the average value was calculated. The average current value (leakage current value) was determined for each first electrode, with the average current value of the first electrode Y1 taken as 100%. The results are shown in Table 3. In Table 3, the average current value of the first electrode X2 is also shown for reference.

TABLE 3

| First electrode | X1 | X2 | Y1 | Y2 | Y3 |
|---|---|---|---|---|---|
| Leakage current (%) | 64 | 85 | 100 | 75 | 71 |

### INDUSTRIAL APPLICABILITY

The electrode produced by the method according to the present invention can suppresses the leakage current, and therefore is applicable to electrolytic capacitors for various purposes.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

100: electrolytic capacitor

10: capacitor element
11: first electrode
   111: metal material (porous sintered body)
   112: electrode wire
   113: oxide film
13: second electrode
   131: solid electrolyte layer
   132: carbon layer

133: metal paste layer

20: package body

30: first lead terminal

40: second lead terminal

50: adhesive layer

1. A method for producing an electrode for an electrolytic capacitor, the method comprising:
a chemical conversion step of allowing a current to flow through a metal material containing a valve metal in a chemical conversion solution containing an electrolyte, to form an oxide film on a surface of the metal material, wherein
the chemical conversion solution contains a nitrate-based compound as the electrolyte at a concentration of 0.03 mass % or more, and
a phosphorus compound concentration in the chemical conversion solution is less than 0.01 mass %.

2. The method for producing an electrode for an electrolytic capacitor according to claim 1, wherein a concentration of the nitrate-based compound is 15 mass % or less.

3-4. (canceled)

5. The method for producing an electrode for an electrolytic capacitor according to claim 1, wherein the metal material is a porous sintered body containing tantalum.

6. An electrode for an electrolytic capacitor, comprising:
a metal material including a valve metal; and
an oxide film formed on a surface of the metal material, wherein
a phosphorus concentration measured by an energy dispersive X-ray spectroscopy of the oxide film is below a detection limit.

7. (canceled)

8. An electrode for an electrolytic capacitor, comprising:
a metal material including a valve metal; and
an oxide film formed on a surface of the metal material, wherein
the oxide film includes an oxide of tantalum, and
in a spectrum obtained by an electron energy loss spectroscopy of the oxide film, a difference between an average intensity I_{1A} of a first peak observed between 530 eV and 550 eV and an average intensity I_{2A} of a second peak observed between 560 eV and 570 eV is 10% or less of the average intensity I_{1A} of the first peak.

9-10. (canceled)

11. An electrolytic capacitor, comprising the electrode for an electrolytic capacitor of claim 6.

12. An electrolytic capacitor, comprising the electrode for an electrolytic capacitor of claim 8.
